(19) United States
(12) Patent Application Publication
(10) Pub. No.: US 2013/0026981 A1
(43) Pub. Date: Jan. 31, 2013

(54) DUAL MODE WIRELESS POWER

(71) Applicant: REINIERUS HENDRICUS MARIA VAN DER LEE, LAKE FOREST, CA (US)

(72) Inventor: REINIERUS HENDRICUS MARIA VAN DER LEE, LAKE FOREST, CA (US)

(73) Assignee: BROADCOM CORPORATION, Irvine, CA (US)

(21) Appl. No.: 13/193,265

(22) Filed: Jul. 28, 2011

(51) Int. Cl. H02J 7/00; H02J 17/00; H01F 38/14

(52) U.S. Cl. 320/108; 307/104

(57) ABSTRACT

A dual mode wireless power module for a device includes a wireless transceiver and a wireless power transceiver circuit. The wireless transceiver circuit is operable to communicate peripheral power information indicating a wireless power configuration. The wireless power transceiver circuit is operable to determine, based upon the power information, a power status of another device identified by the peripheral power information. When the power status of the another device is favorable, the wireless power transceiver circuit is placed in a wireless power receive mode in which the wireless power transceiver circuit converts wireless power into a voltage. When the power status of the another device is unfavorable, the wireless power transceiver circuit is placed in a wireless power transmit mode in which the wireless power transceiver circuit converts a power source of the device into the wireless power.

### BACKGROUND

1. Technical Field

The invention generally relates to wireless electrical power transmission.

2. Related Art

Conceptually, wireless power for powering a device without interconnecting wires has been around for a period of time, and has recently undergone commercialization. Also, wireless power system standardization discussions have been on-going (for example, the Wireless Power Consortium (WPC), the Consumer Electronics Association (CEA), et cetera).

Commercial wireless power products generally include either of a transmit unit or a receive unit, and a bidirectional control channel. In these products, the primary method of energy transfer is inductive coupling, but some lower power applications may include solar energy transfer, thermo-electronic energy transfer, and/or capacitive energy transfer. To use these products, the receive unit has been a separate unit coupled to a device that is to be wirelessly powered. Thus, the device itself cannot be wirelessly powered without a receive unit.

To develop these products, effort has been spent on inductive power transfer, closed loop systems, and multiple load support. These systems, however, are rigid in the wireless power transfer mechanisms, and do not address dual mode wireless power transfer for a device.

Though effort has been spent to commercialize wireless power systems, significant effort is needed to make cost-effective and/or feature rich wireless power systems with intelligence to support a dual mode wireless power feature.

### BRIEF DESCRIPTION OF THE DRAWINGS

FIG. 1 is a diagram of an example wireless power transfer system in accordance with an embodiment of the present invention.

FIG. 2 is a schematic block diagram of an embodiment of dual mode wireless power modules within a wireless power computer system in accordance with an embodiment of the present invention.

FIG. 3 is a block diagram depicting a computer dual mode wireless power module of the present invention.

FIG. 4 is a schematic block diagram of an embodiment of a peripheral device dual mode wireless power module in accordance with an embodiment of the present invention.

FIG. 5 is a logic diagram of a method for managing a wireless power transfer in accordance with an embodiment of the present invention.

FIG. 6 is a logic diagram of a method to determine power status for another device in a wireless power environment in accordance with an embodiment of the present invention.

### DETAILED DESCRIPTION OF THE DRAWINGS

As used herein, the term wireless power transfer refers to a process by which electrical energy is transmitted from a power source to an electrical load without interconnecting wires. Systems that transfer power wirelessly are generally based on the concept of electromagnetic induction rather than electromagnetic radiation. These systems include systems based on inductive coupling or “resonant inductive coupling.”

Inductive coupling refers to the transfer of energy from one circuit component to another through a shared electromagnetic field. In inductive coupling, a current running in an emitting coil induces another current in a receiving coil. The two coils are in proximity, but do not physically touch.

Inductive coupling may be used in a variety of systems, including but not limited to systems that wirelessly charge a battery in a portable electronic device. In such systems, the portable electronic device is placed in close proximity to a charging station. A first induction coil in the charging station is used to create an alternating electromagnetic field, and a second induction coil in the portable electronic device derives power from the electromagnetic field and converts it back into electrical current to charge the battery.

Another example of an embodiment based on inductive coupling to wirelessly transfer power is Near Field Communication (NFC). NFC is a short-range high frequency wireless communication technology that enables the exchange of data between devices over approximately a decimeter distance. NFC is an extension of the ISO/IEC 14443 proximity-card standard that combines the interface of a smartcard and a reader into a single device. An NFC device can communicate with both existing ISO/IEC 14443 smartcards and readers, as well as with other NFC devices, and is thereby compatible with existing contactless infrastructure already in use for public transportation and payment. The air interface for NFC is described in ISO/IEC 18092/ECMA-340: Near Field Communication Interface and Protocol-1 (NFCIP-1) and ISO/IEC 21481/ECMA-352: Near Field Communication Interface and Protocol-2 (NFCIP-2).

NFC devices communicate via magnetic field induction, wherein loop antennas are located within each other's near field, effectively forming an air-core transformer. In a passive communication mode, an initiator device provides a carrier field and a target device answers by modulating the existing field. In this mode, the target device may draw its operating power from the initiator-provided electromagnetic field.

“Resonant inductive coupling” refers to a form of inductive coupling that utilizes magnetically-coupled resonators for wirelessly transferring power. In a system that uses resonant inductive coupling, a first coil attached to a sending unit generates a non-radiative magnetic field oscillating at megahertz frequencies. The non-radiative field mediates a power exchange with a second coil attached to a receiving unit, which is specially designed to resonate with the field. The resonant nature of the process facilitates a strong interaction between the sending unit and the receiving unit, while the interaction with the rest of the environment is weak. Power that is not picked up by the receiving unit remains bound to the vicinity of the sending unit, instead of being radiated into the environment and lost.

Resonant inductive coupling increases wireless power transfer efficiency over distances that are a few times the size of the device to be powered, therefore exceeding the performance of systems based on non-resonant inductive coupling.

The growth of portable electronic devices such as laptop computers, cellular telephones and portable media devices, brings a strong demand for systems that facilitate the wireless recharging of power sources based on various types of near field inductive coupling such as those described above. In such instances, a capability for a portable device to engage in a transmission or reception of wireless devices with a proximal range is desired.

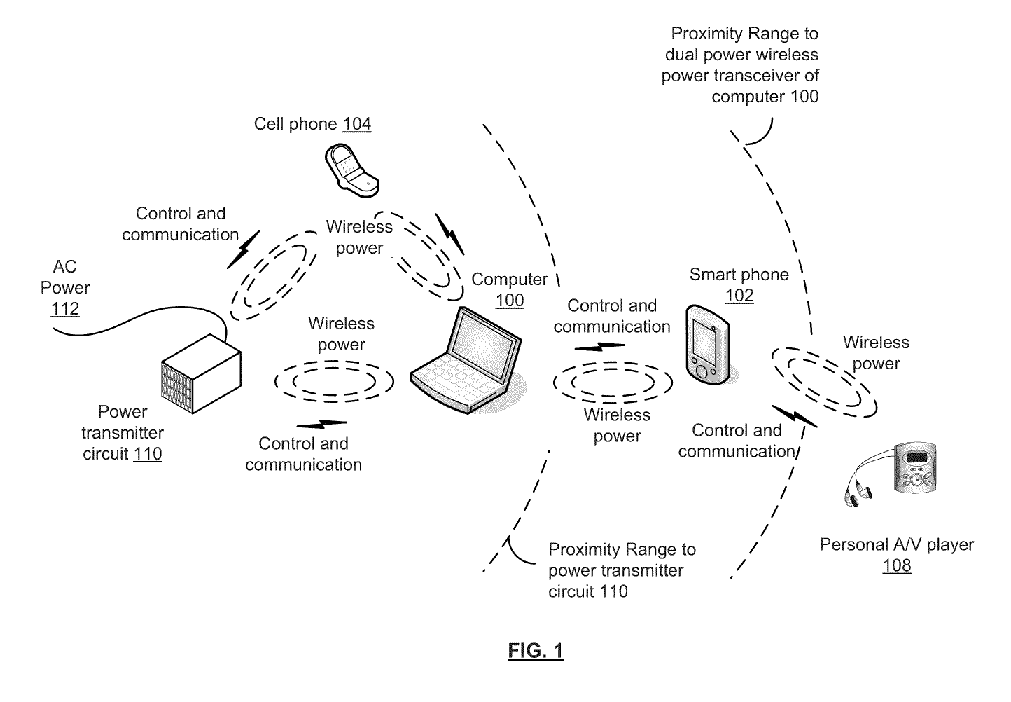

FIG. 1 is a schematic block diagram of an embodiment of a wireless power computer system that includes a computer 100, a smart phone 102, a cell phone 104, a personal audio/video (A/V) player 108, an AC power 112, and potentially other peripheral computer devices (for example, joy stick, touch pad, track ball, speakers, a wireless keyboard, a wireless mouse, an external hard drive, et cetera). Other examples of devices include medical devices, data collection devices with remote readout, et cetera. The computer 100 may be a laptop, a panel display computer (for example, a tablet), a conventional desktop computer, et cetera and includes a dual mode wireless power module.

For clarity, in discussion of the Figures, the computer 100 may be referred to as a primary device, and the other devices as peripheral devices. The understanding being that these labels for the purpose of convenience and clarity, and with the further understanding that some or all of the devices may include a dual mode wireless power module as discussed herein.

In this embodiment, the computer 100 is powered wirelessly via the power transmitter circuit 100 (that is, a wireless power transmitter unit) coupled to a constant or large power source, such as an alternating current (AC) power source. The power transmitter circuit 100 may also provide wireless power to the peripheral components within general proximity, as provided by the wireless power technology (for example, cell phone 104, personal AV player 108, hard drive, et cetera).

The peripheral devices, such as cell phone 104, smart phone 102, and personal A/V player 108 may be wirelessly powered concurrently from the computer 100 and/or sequentially. Each of the peripheral devices 102, 104, and 108, wirelessly communicates via control and communication links with the computer 100 using conventional wireless communication protocols (such as Bluetooth) and or use a wireless power control channel.

While FIG. 1 illustrates a computer system, the concepts provided herein apply to a more generic system. For example, a wireless power system may include a primary device (for example, a computer, television, monitor, cable set-top box, satellite set-top box, home electronic appliance, et cetera) and at least one peripheral device (such as, those of FIG. 1, audio and/or video entertainment components, remote controllers, et cetera).

Each of the devices may include a dual mode wireless power module to support wireless power transmission and reception, and the capability to communicate power information for the devices to indicate behavior in a wireless power transmit mode or a wireless power receiver mode. Further, other devices may be legacy devices, that either transmits wireless power, such as the power transmitter circuit 110 providing power from AC power 112, or is limited to receiving wireless power.

Within a device including a dual mode wireless power module, for example, the computer 100 (which for discussion is referred to as a primary device), a computer power module converts a power source into a wireless power link for power transmission to devices having configurations for receiving and converting the wireless power to a source voltage. For example, the device power module may include a power supply and a wireless power transceiver circuit. The power supply converts the power source (for example, an AC voltage or received wireless power signal) into an output DC voltage. In a dual mode wireless power operation, the wireless power transceiver circuit converts the output DC voltage into the wireless power link when in a wireless power transmit mode, and converts the wireless power into a supply voltage when in a wireless power receive mode.

In configurations with multiple wireless power links such as that shown in FIG. 1, the wireless power links between the computer 100 and the cell phone 104 may have a first frequency f1, and the wireless power link between the computer 100 and the smart phone 102 may have a second frequency f2 to minimize interference therebetween.

The determination a power status of one of the devices, such as the smart phone 102, the cell phone 104, the personal A/V player 108, may be with regard to power information communicated via the control and communication link between the device. For example, the power information may include power source identifier for the peripheral device, a wireless power capability of the device, whether dual mode wireless power is enabled for the device, wireless power transmit capability, or wireless power receive capability. Moreover, the power information may include a device power priority giving precedence over lower prioritized devices for limited or discrete power resources in a battery-based system (that is, a system in which a power transmitter circuit 110 is unavailable to provide virtually bottomless power resources). For example, a device may be designated in a factory setting as having priority for finite power resources (such as a cell phone 104) in the need to communicate in emergencies, or lower based upon purely entertainment function (such as the personal A/V player 108). In other contexts, a user may configure the device power priority based upon their individual preferences, such as via a user interface for the device.

The power information may further include at least one of a communication protocol, input data, input command, output data, and output command. For example, with interaction with a user input device (such as a touch or tactile screen, keypad, mouse, keyboard, et cetera), the user input device may generate data and/or a command for execution by the display device, such as a display screen on the personal A/V player 108. As another example, if the device setup includes a memory device such as a wireless disk drive or flash drive, and the peripheral device is a user output device such as the display screen and speakers of the personal A/V player 108, the memory device provides data to the user output device for display of audible and/or visual data.

The devices also communicate information regarding the wireless power link with the wireless transceiver of the another device, such as peripheral devices 102, 104 and/or 108. The information regarding the wireless power link includes control channel protocol, frequency of the wireless power link, impedance matching parameters, resonant frequency tuning parameters, and/or other electromagnetic properties discussed herein.

In addition to a dual mode wireless power module, a device may further include a battery, a battery charger, and a processing module. The battery charger utilizes the supply voltage to charge the battery as discussed with reference to one or more of the figures. The processing module coordinates the charging of the battery, the communicating of the information regarding the wireless power link, and the communicating of the power information.

The dual mode wireless power transceiver circuit of the peripheral device converts the wireless power link into a voltage, or a voltage into a wireless power link, when in a wireless power receive mode, as discussed with reference to one or more of the figures. The peripheral device may generate input data for the computer 100, wherein the peripheral power information includes input data. As another example, the peripheral device may generate an input command for the computer 100, wherein the power information includes the input command. As another example, the peripheral device may perform a function on output data from the computer 100, wherein the peripheral information includes the output data. As another example, the peripheral device may perform a function in accordance with an output command from the computer 100, wherein the peripheral information includes the output command.

In addition to including a wireless power transceiver, the peripheral device, such as cell phone 104, smart phone 102, and/or personal A/V player 108, may further include a battery, a battery charger, and a processing module. The battery charger utilizes the supply voltage to charge the peripheral battery. The processing module of the peripheral device coordinates the charging of the battery, the communicating of the information regarding the wireless power link, and the communicating of the peripheral information.

The primary device and/or the peripheral device may include an integrated circuit (IC) to support the above-described functions. For example, an IC may include at least a portion of the wireless power transceiver circuit (for example, one or more of the coil, capacitor, and diodes of the rectifying circuit may be off-chip), at least a portion of the battery charger (for example, one or more of the switching transistors, the output filter capacitor, the inductor may be off-chip), the transceiver, and the processing module.

In accordance with the foregoing method, the wireless control and communication link may be established in accordance with one of a Near Field Communication (NFC) protocol, a Bluetooth™ protocol, a ZigBee™ protocol, an IEEE 802.11 protocol, et cetera.

Generally, when charging is needed for either device, the device providing transmission of the wireless power determines whether the device to receive the wireless power is in range for charging. Note that when the devices use an RF and/or MMW communication protocol, the range of communication can be up to 10 meters while the range for charging will typically be close range, or within the decimeter range. The range is generally a functions of the inductor diameter and physical structure, which indicates the electromagnetic field strength and the associated attenuation characteristics to achieve a desired transfer efficiency. For example, in resonant technologies, the diameter of the inductor coil diameter is regarded as a practical maximum distance. In non-resonant technologies, the field distance is presently about five millimeters. Nevertheless, as technologies improve, further distances or spans for wireless power transmission will be realized. When the devices are in charging range, charging parameters are selected for effecting the wireless power transmission and reception (for example, coil selection, power levels, frequency, impedance matching settings, etc.) for the peripheral device.

As a further example, a device may provide overlapping transmission and reception of wireless power. In this manner, the device provides a wireless power chain for powering devices outside of the proximity range to the power transmitter circuit 110. That is, the computer 100 may provide wireless power to the smart phone 102, which is within the proximity range to the dual power wireless power transceiver of computer 100. In one aspect, the computer 100 may transmit wireless power to the smart phone 102, and then receive in a staggered fashion, wireless power from the power transmitter circuit 110. Such staggered power provisioning (either receiving or transmitting wireless power) is coordinated via the control and communication link between the power transmitter circuit 110 and the computer 100.

In another aspect, the computer 100 may receive and transmit wireless power in an overlapping fashion, in which while transmitting wireless power to the smart phone 102, the computer 100 may also be receiving wireless power from the power transmitter circuit 110. The overlapping fashion provides substantially simultaneous transmission and reception of wireless power where wireless power reception and transmission periods overlap for the device. The respective transmission and reception periods depending on factors such as the battery charge rate of the computer 100 (that is battery saturation/charge from the power transmitter circuit 110), the rate of depletion to the computer 100 by providing power to the smart phone 102, the battery charge rate of the smart phone 102, et cetera. As should be noted, the computer 100 may provide wireless power in a staggered fashion, an overlapping fashion, or a combination thereof.

The foregoing method may further include establishing the wireless power link. The wireless power link may be established based on inductive (or non-resonant) coupling or on resonant inductive coupling. The wireless communication link and the wireless power link may also be established via the same inductive link. The foregoing method may further include monitoring an amount of power wirelessly transferred to the portable electronic device and charging a user of the portable electronic device based on the monitored amount.

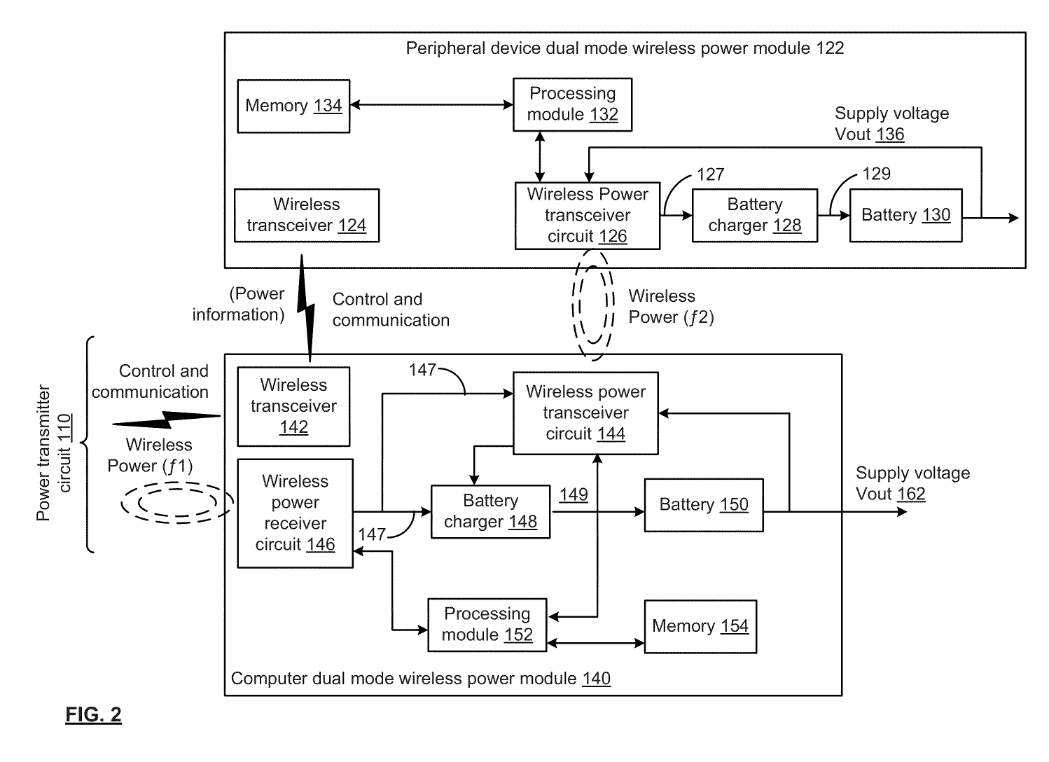

FIG. 2 is a schematic block diagram of an embodiment of dual mode wireless power modules (for example computer dual mode wireless power module 140 and peripheral device dual mode wireless power module 122) within a wireless power computer system. The computer dual mode wireless power module 140 includes a wireless transceiver 142, a power receiver circuit 146, a battery charger 148, a battery 150, a wireless power transceiver circuit 144, a processing module 152, and memory 154. The peripheral device dual mode wireless power module 122 includes a wireless transceiver 124, a wireless power transceiver circuit 126, a battery charger 128, and a battery 130.

In an example of operation, the mode wireless power transmit circuit 110 generates an electromagnetic field that is received by the power receiver circuit 146 of the computer dual mode wireless power module 140 to facilitate a wireless power transference. The power receiver circuit 146 generates a DC rail voltage 147 in accordance with control signals provided by the processing module 152. The battery charger 148 converts the DC rail voltage 147 into a battery charge voltage 149, which is supplied to the battery 150, which outputs a supply voltage Vout 162.

The processing module 152 places the wireless power transceiver circuit 144 in either of a wireless power transmit mode or a wireless power receive mode based upon power information from the dual mode wireless power module 122, via the processing module 132 and memory 134 of the peripheral device. Moreover, the processing module 132 places the wireless power transceiver circuit 126 in a complementary mode of operation.

When in a wireless power transmit mode, the wireless power transceiver circuit 144 generates an electromagnetic field that is electromechanically coupled to the wireless power transceiver circuit 126 of the peripheral device dual mode wireless power module 122. The wireless power transceiver circuit 144 may be sourced by the DC rail voltage 147 when the computer dual mode wireless power module 140 is sufficiently proximal to the power transmitter circuit 110, or sourced by the supply voltage Vout 162 from the battery 150 when the computer dual mode wireless power module 140 is not sufficiently proximal to the power transmitter circuit 110.

When in a wireless power receive mode, the wireless power transceiver circuit 144 receives an electromagnetic field that is electromechanically coupled to the wireless power transceiver circuit 126 of the peripheral device dual mode wireless power module 122. The wireless power transceiver circuit 144 converts the wireless power link into a voltage delivered to the battery charger 148, which in turn charges the battery 150.

The wireless power transceiver circuit 126 of the peripheral device dual mode wireless power module 126 generates a DC rail voltage 127 from the electromagnetic field of the wireless power transceiver circuit 144. The battery charger 128 converts the DC rail voltage 127 into a battery charger voltage 129, which is provided to the battery 130 that in turn provides supply voltage Vout 136.

The computer dual mode wireless power module 140 communicates with the peripheral device dual mode wireless power module 122 with power information via the wireless transceivers 142 and 124, respectively, using a control and communication link (for example, Radio Frequency (RF), Bluetooth, Millimeter Wave (MMW), Near Field Communications (NFC), et cetera) regarding wireless power matters (such as, frequency selection, operating frequency, impedance matching settings, power levels, et cetera).

In addition, the wireless transceivers 142 and 124 may be used to convey data between the peripheral device and the computer. For example, if the peripheral device is a wireless keyboard, the keyboard signaling may be conveyed to the computer via the wireless transceivers. Note that with multiple peripheral devices, each including a wireless transceiver, a local area network is created.

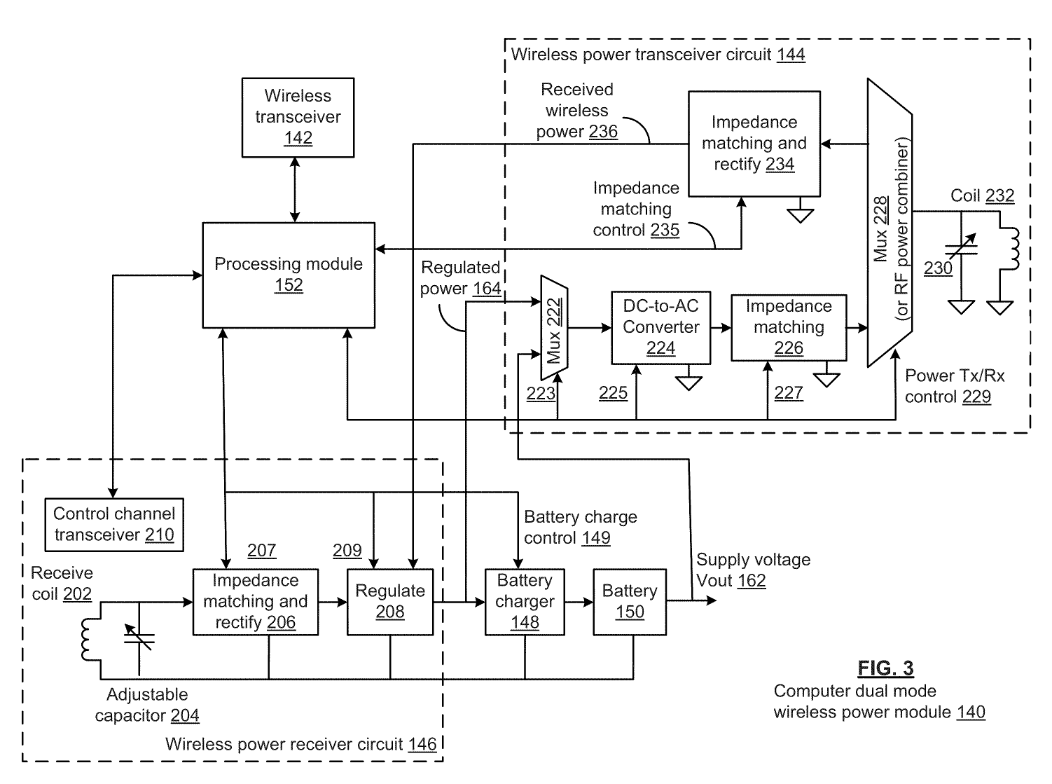

FIG. 3 is a schematic block diagram of an embodiment of a computer dual mode wireless power module 140 that includes the wireless power receiver circuit 146, the battery charger 148, the battery 150, the wireless power transceiver circuit 144, the wireless transceiver 142, and the processing module 152.

The wireless power receiver circuit 146 includes receive (RX) coil 202, an adjustable capacitor 204, the impedance matching & rectify circuit 206, the regulation circuit 208, and the control channel transceiver 210. The wireless power conversion transceiver circuit 144 includes a multiplexer 228, a DC-to-AC converter 224, an impedance matching circuit 226, an impedance matching and rectify circuit 234, an adjustable capacitor 230, and a coil 232.

In an example of operation, the receive coil 202 of the wireless power receiver circuit 146 generates an AC voltage from the wireless power link it receives from the transmit coil of the wireless power transmit circuit 110 (see FIG. 2). The impedance matching and rectify circuit 206 converts the AC voltage from the receive coil 202 and adjustable capacitor 204 into a DC rail voltage, as with a bridge rectifier circuit. The DC rail voltage is then regulated via the regulate circuit 208. The regulate circuit 208 may be embodied, for example, as a buck and/or boost converter, in which the regulate circuit 208 operates in a buck converter mode when the DC voltage rail is to be stepped down to produce battery charge voltage and operates in a boost converter mode when the DC rail voltage is to be stepped up to produce the battery charge voltage. Note that the buck and/or boost converter circuitry of the regulate circuit 208 may include multiple inductors, transistors, diodes, and capacitors to produce multiple supply voltages. The battery charger 148 uses the regulated DC rail voltage to charge the battery 150, which produces a supply voltage Vout 162.

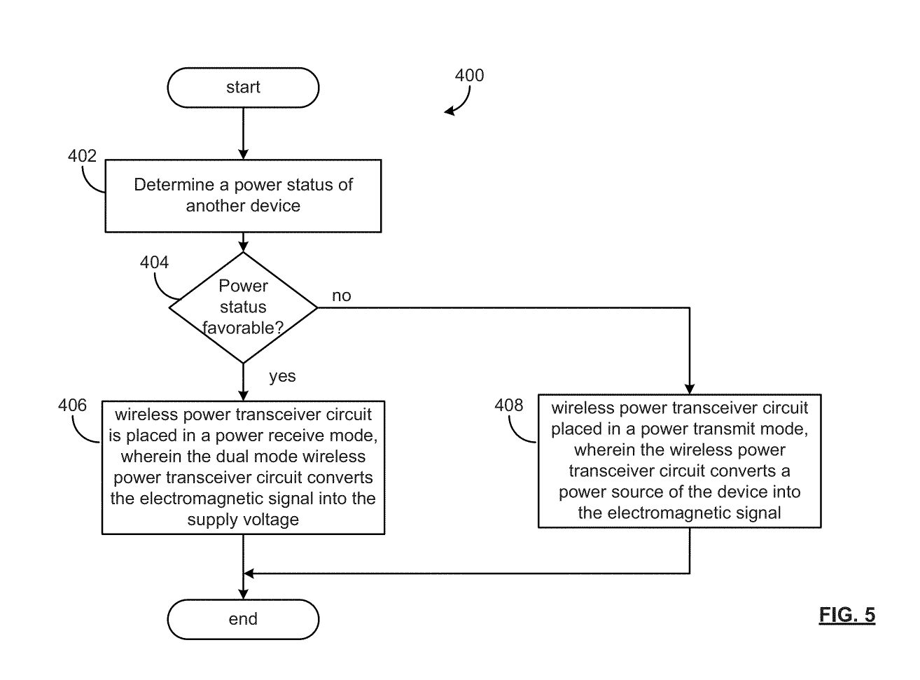

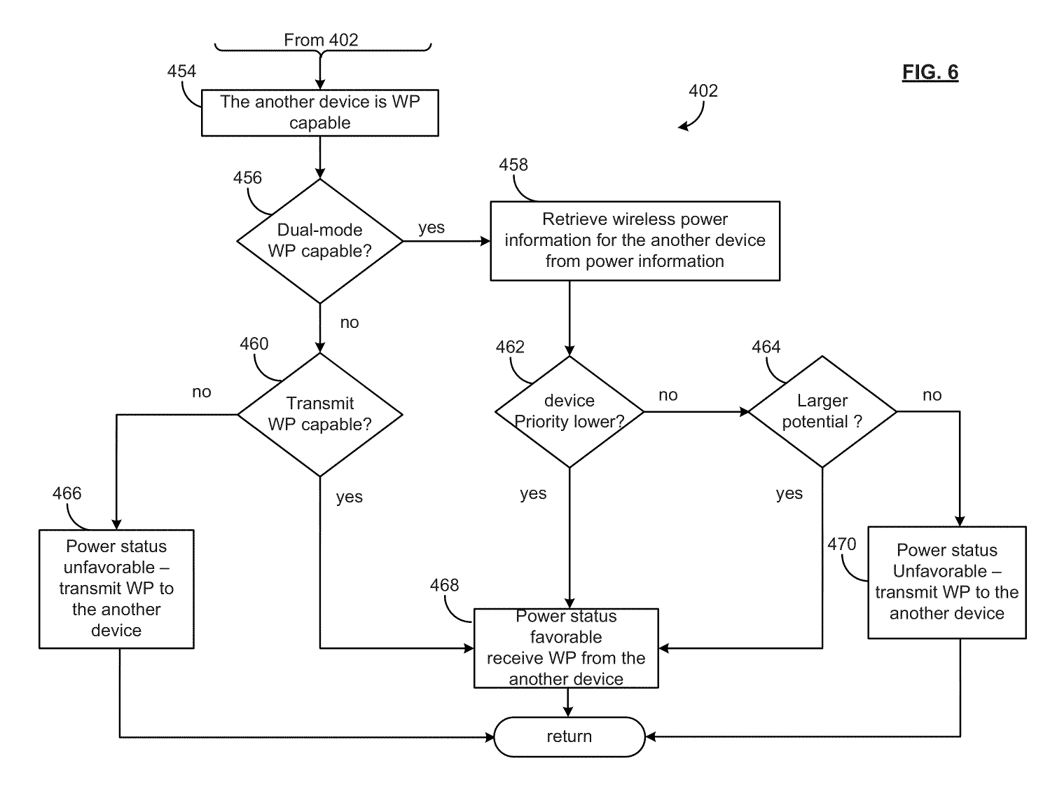

When in a wireless power transmit mode, as dictated by the power Tx/Rx control 229 from the processing module 152, the wireless power transceiver circuit 144 is powered by two possible sources, the first being the regulated power 164 (that is, a regulated rail voltage) when receiving wireless power from wireless power receiver circuit 146, and the second being the battery 150 via the supply voltage Vout 162 when the computer is in a battery operated mode (further presuming the battery 150 has sufficient energy to charge other devices, as is discussed later in further detail with respect to FIGS. 5 and 6).

In the wireless power transmit mode, the DC-to-AC converter 224 converts the regulated power 164 to an AC voltage that is provided to the coil 232 via the impedance matching circuit 226 and MUX 228. The DC-to-AC converter 224 includes a full bridge inverter topology to excite the coil 232. The DC-to-AC control signal 225 generates the switching signals to drive the DC-to-AC converter 224 at a desired frequency. In an alternate embodiment, the DC-to-AC converter 224 may include a half bridge inverter topology. The impedance matching circuit 226, based upon the impedance control 227, adjusts the impedance of the capacitor 230 and/or coil 232 to a desired resonance and/or quality factor. As an example, the impedance matching circuit 226 may tune the capacitor 230 and coil 232 to resonate at the switching frequency of the DC-to-AC converter 224, to be an under-damped circuit, or an over-damped circuit. The coil 232 generates a wireless power link that is received by the coil of a peripheral device dual mode wireless power module.

When in a wireless power receive mode, such as when the computer dual mode wireless power module 140 does not receive wireless power via the wireless power receiver circuit 146, as indicated through the power Tx/Rx control 229 from the processing module 152, the coil 232 of the wireless power transceiver circuit 144 receives a wireless power signal transmitted by the coil another device having a peripheral device dual mode wireless power module. In this mode, the impedance matching and rectify circuit 234 converts the AC voltage into a received wireless power 236, which is rectified to a DC voltage. The DC voltage is regulated via the regulate circuit 208 for the battery charger 148, which in turn charges the battery 150.

The processing module 142 provides a power Tx/Rx control signal 229 to the MUX 228 to place the wireless power module 122 in either of a wireless power transmit or a wireless power receive mode of operation. The MUX 228 may transmit or receive wireless power in a staggered fashion, in which the wireless power transceiver circuit 144 either receives or transmits wireless power.

In a further embodiment, a RF power combiner may be used for the multiplexer 228 when receive and transmit wireless power frequencies are sufficiently far apart in operational frequencies to be distinguishable by the RF power combiner. In this regard, the wireless power transceiver circuit 144 may operate in an overlapping fashion, in which substantially simultaneous periods of transmission and reception of wireless power occur by the wireless power transceiver circuit 144. In this manner, the wireless power transceiver circuit 144 may operate in a duplex mode, in which both wireless power transmission and wireless power reception may be realized. Further, the wireless power transceiver so configured may operate in a staggered fashion, an overlapping fashion, or a combination thereof.

Moreover, the processing module 142 provides a power selection signal 223 to the MUX 222 between the regulated power 164 and the supply voltage Vout 162 for wireless power transmission via the wireless power transceiver circuit 144. Moreover, the processing module 132 implements a battery charge control 149, a regulate control 209, an impedance matching circuit control 207, 227, and 235, a DC-to-AC control 225, and provide for RF/MMW and/or NFC baseband processing.

Note that the processing module 152 may be fabricated on a single integrated circuit or on a multiple integrated circuit with one or more of the components of the regulator 208, the rectifier portion of the impedance matching and rectify circuit 206 and 234, battery charger 148, and/or a battery current sense.

In an embodiment, the AC voltage of the RX coil 202 of the wireless power receiver circuit 146 of the computer dual mode wireless power module 140 may have substantially the same frequency, where f1=f2, or a different frequency than the AC voltage of the coil 232 of the wireless power transceiver circuit 144, where f1>f2 or f1<f2. Frequency separation and differentiation further facilitates operation in the overlapping fashion for wireless power transmission and reception as discussed herein.

When the computer is in a battery operated mode which either transmits wireless power or receives wireless power, the wireless power transceiver circuit 144 generates the wireless power link as described above if the battery 150 has sufficient power (for example, a desired battery life level) to charge one or more other devices. If the battery 650 does not have sufficient power to provide charge to other devices, or is at a threshold level requiring further charging, the wireless power transceiver circuit 144 is placed in a wireless power receive mode to receive a wireless power signal generated by another device, and to charge the battery 150.

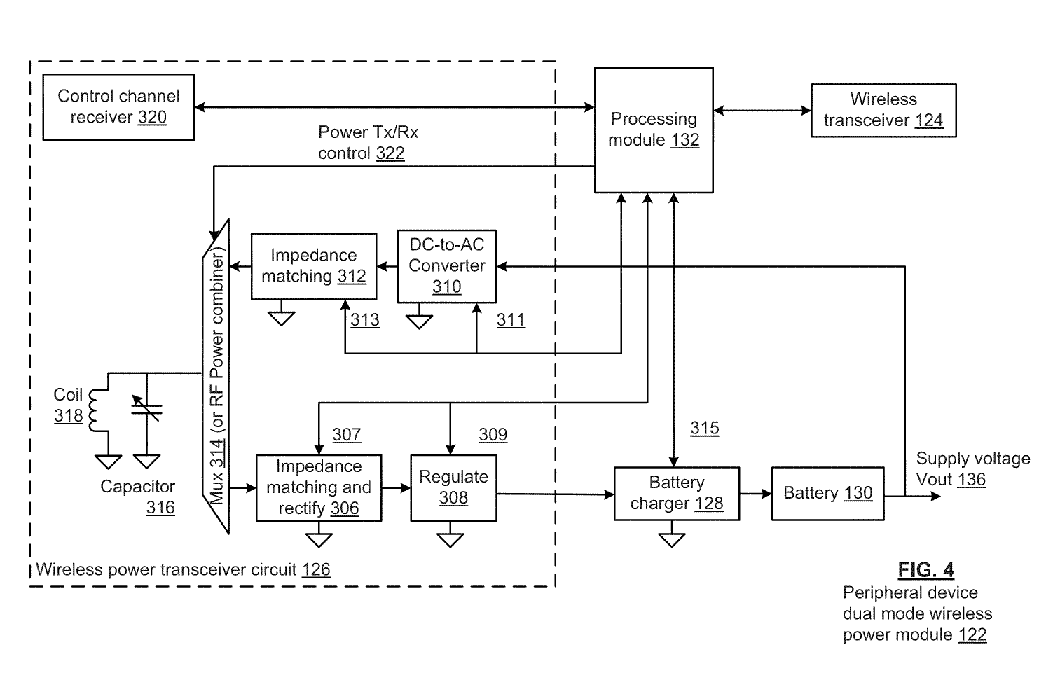

FIG. 4 is a schematic block diagram of an embodiment of a peripheral device dual mode wireless power module 122 that includes a coil 318, an adjustable capacitor 316, a MUX 314, a wireless power receive branch including an impedance matching and rectifying circuit 307, a regulate circuit 309, a battery charger 128, a battery 130, a wireless power transmit branch including an impedance matching circuit 312, a DC-to-AC converter 310, a processing module 132, a wireless transceiver 124, and control channel receiver 320.

The processing module 132 provides a power Tx/Rx control signal 322 to the multiplexer 314 to place the wireless power module 122 in either of a wireless power transmit or a wireless power receive mode of operation. The MUX 314 may transmit or receive wireless power in a staggered fashion, in which the wireless power transceiver circuit 126 either receives or transmits wireless power.

In a further embodiment, a RF power combiner may be used for the multiplexer 314 when receive and transmit wireless power frequencies are sufficiently far apart in operational frequencies to be distinguishable by the RF power combiner. In this regard, the wireless power transceiver circuit 126 may operate in an overlapping fashion, in which substantially simultaneous periods of transmission and reception of wireless power occur by the wireless power transceiver circuit 126. In this manner, the wireless power transceiver circuit 126 may operate in a duplex mode, in which both wireless power transmission and wireless power reception may be realized. Further, the wireless power transceiver circuit 126, so configured, may operate in a staggered fashion, an overlapping fashion, or a combination thereof.

Moreover, the processing module 132 implements a battery charger controller 315, a regulate controller 309, an impedance matching circuit control 307 and 313, a DC-to-AC control 311, and provide for RF/MMW and/or NFC baseband processing.

Note that the processing module 132 may be fabricated on a single integrated circuit or on a multiple integrated circuit with one or more of the components of the regulator 308, the rectifier portion of the impedance matching and rectify circuit 306, battery charger 128, and/or a battery current sense 315.

As noted earlier, the wireless the wireless transceiver 124 and the control channel receiver 320 provide a using a control and communication link (for example, Radio Frequency (RF), Bluetooth, Millimeter Wave (MMW), Near Field Communications (NFC), et cetera) regarding wireless power matters (such as, frequency selection, operating frequency, impedance matching settings, power levels, et cetera). In addition, the wireless transceiver 124 may be used to convey data between the peripheral device and the computer. For example, if the peripheral device is a wireless keyboard, the keyboard signaling may be conveyed to the computer via the wireless transceivers. Note that with multiple peripheral devices, each including a wireless transceiver, a local area network is created.

The wireless power transceiver circuit 126 operates to coordinate communication of the control channel information with other devices via the control channel receiver 320.

In an example of wireless power receive operation, the coil 318 generates an AC voltage from a wireless power signal it receives from a coil of the computer dual mode wireless power module. The coils may include one or more adjustable inductors. The impedance matching and rectify circuit 306 converts the AC voltage into a DC rail voltage that is regulated via the regulate circuit 308. The regulate circuit 308 includes a buck &/or boost converter circuit, in which the regulate circuit 308 operates in a buck converter mode when the DC voltage rail is to be stepped down to produce battery charge voltage and operates in a boost converter mode when the DC rail voltage is to be stepped up to produce the battery charge voltage. Note that the buck and/or boost converter circuitry of the regulate circuit 308 may include multiple inductors, transistors, diodes, and capacitors to produce multiple supply voltages.

The battery charger 128 uses the DC rail voltage to charge the battery 130, such as via a trickle charge circuit monitored and controlled by control signal 315. The battery produces a supply voltage Vout 136.

When in a wireless power transmit mode, as dictated by the power Tx/Rx control 322 from the processing module 132, the wireless power transceiver circuit 126 is powered by the battery 130 via the supply voltage Vout 136, presuming the battery 130 has sufficient energy to charge other devices, as is discussed later in further detail with respect to FIGS. 5 and 6).

In the wireless power transmit mode, the DC-to-AC converter 130 converts the supply voltage Vout 136 to an AC voltage that is provided to the coil 318 via the impedance matching circuit 312 and the MUX 314. The DC-to-AC converter 310 includes a full bridge inverter topology to excite the coil 318. The DC-to-AC control signal 313 generates switching signals to drive the DC-to-AC converter 310 at a desired frequency. In an alternate embodiment, the DC-to-AC converter 312 may include a half bridge inverter topology.

The impedance matching circuit 312, based upon the impedance control 313, adjusts the impedance of the capacitor 316 and/or coil 318 to a desired resonance and/or quality factor. As an example, the impedance matching circuit 313 may tune the capacitor 316 and coil 318 to resonate at the switching frequency of the DC-to-AC converter 310, as an under-damped circuit, or an over-damped circuit. The coil 318 generates a wireless power signal that is received, for example, by the coil of a computer dual mode wireless power module.

When the battery 130 is charging, the battery charge control 315 operates to monitor the battery 130 current and voltage to ensure charging is in accordance with the charging requirements of the battery 130. When the battery 130 is charged, the battery 130 is disconnected from the regulate circuit 308. The battery 752 may also be trickle charged.

FIG. 5 is a logic diagram of an embodiment of a method 400 for managing a wireless power computer system that begins with the computer power module receiving power information from another device, such as a peripheral device, via one or more communication channels at step 402.

The power information indicates a wireless power configuration, including one or more of full battery capacity, charging history (e.g., times, durations, charge voltage, charge current, trickle charge reached, etc.), current battery life, current loading, loading history, etc. Moreover, the power information includes a power source identifier identifying the device or devices, wireless power capability (for example, whether dual mode capable, transmit capable, or receive capable); device power priority (indicating the power reception priority for conveying or receiving wireless power); and at least one of a communication protocol, input data, input command, output data; and output command.

From the frame-of-reference of the device receiving the power information, a determination is made whether to place that the dual mode wireless power device in either of a receive wireless power mode when the power status of the other device is favorable, or of a transmit wireless power mode when the power status of the other device is unfavorable.

For example, when a battery level of a computer dual mode wireless power module is low in power, based upon factors such as estimated remaining battery life, whether the battery is at full charge, the type of battery, the charging requirements of the battery, charging being currently supported by the computer wireless power module, et cetera. When the another device exhibits power information favorable to providing power to the computer wireless power module. When the power status is favorable at step 404, then at step 406 the wireless power transceiver circuit is placed in a power receive mode, where the dual mode wireless power transceiver circuit converts wireless power from another device into a supply voltage.

In the other context when the power status of the other device is unfavorable, indicating that the other, or peripheral, device seeks to charge or replenish the peripheral device's battery, and the primary, or computer, device has the voltage capacity and the wireless power transceiver of the computer dual mode wireless power module is placed in a power transmit mode at step 408.

As noted above, device may be in multiple wireless power modes with multiple devices. For example, the device may receive wireless power from a first device, and transmit wireless power to another device in an overlapping fashion, in staggered fashion, or a combination thereof.

FIG. 6 is a logic diagram of an embodiment of a method 402 for determining the power status of another device, such as a peripheral device, with respect to a present device, such as a computer, that begins with the computer dual mode wireless power module receiving power information of another device, such as a peripheral device. As should be noted, the example provided herewith is with reference to a computer dual mode wireless power module; however, the transmit/receive mode selection of the computer dual mode wireless power module is applicable to other devices with dual mode wireless capability.

At step 454, the dual mode wireless power module receives information indication that the other device is wireless power capable. Such information may be conveyed via the power information, through wireless power sensing, or through other communication with the respective device over RF, MMW and/or NFC communications. From the power information a determination is made at step 456 as to whether the device providing the power information is a dual mode wireless power capable, such as through the wireless power capability indication of the power information.

When the other, or peripheral, device is not dual mode wireless power capable, then at 460, the computer dual mode wireless power module determines whether the other device is either capable of transmitting wireless power, such as a wireless power transmitter circuit (see FIG. 1), or capable of receiving wireless power. When the device is only capable of receiving wireless power, then the power status of the other device is unfavorable, wherein the computer dual mode wireless power module is set in a wireless power transmit mode to convey power to the other device at step 466.

When the device is only capable of transmitting wireless power, then the power status is favorable, wherein the computer dual mode wireless power module is set in a wireless power receive mode to receive power from the other device at step 468.

When at step 456 the device providing the power information is dual mode wireless power capable, as is the computer dual mode, the computer dual mode wireless power module retrieves wireless power information at step 458 for the peripheral device from the power information. Such wireless power information includes coil selection, power levels (e.g., battery or static source power levels), wireless power frequency, impedance matching settings, et cetera for the peripheral device. Further information includes a power source identifier for the device, the wireless power capability (wireless power dual mode, wireless power receive only, or wireless power transmit only), and device power priority.

With this information, further negotiation between the devices is accomplished, in which device serves as the wireless power transmitter and as the wireless power receiver. At step 462, a determination is made whether there is a device priority level. The device priority level indicates a lower ranked device provides power to a higher ranked device. The device priority level may be designated at a default or factory setting, or may be selected by user input via a user interface. In the present example, when the priority of the peripheral device is lower, the power status is favorable for the computer dual mode wireless power module to receive wireless power in a receive mode, as set out in step 468.

When the power information indicates a higher priority level for the peripheral device at step 462, the wireless power negotiation considers the voltage potentials, or battery charges, of the devices. When the other, or peripheral device has a larger voltage potential at step 464, the indication is that although it has a re-charge preference set by a higher priority level, when the device has a charge or larger potential to spare, the peripheral device may still provide a favorable status in which the computer dual mode wireless power module receives wireless power from the another device at step 468. When the determination is that the peripheral device's potential or charge level is lower, or otherwise insufficient at step 464, then the power status of the computer dual mode wireless power module is set to unfavorable, and enters a wireless power transmission to the peripheral device at step 470. Following the power status determination, the method returns to step 404 of FIG. 5 for configuring the transmit or receive wireless power modes of the wireless power transceiver circuit, accordingly.

The terms “circuit” and “circuitry” as used herein may refer to an independent circuit or to a portion of a multifunctional circuit that performs multiple underlying functions. For example, depending on the embodiment, processing circuitry may be implemented as a single chip processor or as a plurality of processing chips. Likewise, a first circuit and a second circuit may be combined in one embodiment into a single circuit or, in another embodiment, operate independently perhaps in separate chips. The term “chip,” as used herein, refers to an integrated circuit. Circuits and circuitry may comprise general or specific purpose hardware, or may comprise such hardware and associated software such as firmware or object code.

The present invention has also been described above with the aid of method steps illustrating the performance of specified functions and relationships thereof. The boundaries and sequence of these functional building blocks and method steps have been arbitrarily defined herein for convenience of description. Alternate boundaries and sequences can be defined so long as the specified functions and relationships are appropriately performed.

Any such alternate boundaries or sequences are thus within the scope and spirit of the claimed invention.

The present invention has been described above with the aid of functional building blocks illustrating the performance of certain significant functions. The boundaries of these functional building blocks have been arbitrarily defined for convenience of description. Alternate boundaries could be defined as long as the certain significant functions are appropriately performed. Similarly, flow diagram blocks may also have been arbitrarily defined herein to illustrate certain significant functionality. To the extent used, the flow diagram block boundaries and sequence could have been defined otherwise and still perform the certain significant functionality. Such alternate definitions of both functional building blocks and flow diagram blocks and sequences are thus within the scope and spirit of the claimed invention. One of average skill in the art will also recognize that the functional building blocks, and other illustrative blocks, modules and components herein, can be implemented as illustrated or by discrete components, application specific integrated circuits, processors executing appropriate software and the like or any combination thereof.

As may be used herein, the terms “substantially” and “approximately” provides an industry-accepted tolerance for its corresponding term and/or relativity between items. Such an industry-accepted tolerance ranges from less than one percent to fifty percent and corresponds to, but is not limited to, component values, integrated circuit process variations, temperature variations, rise and fall times, and/or thermal noise. Such relativity between items ranges from a difference of a few percent to magnitude differences. As may also be used herein, the term(s) “coupled to” and/or “coupling” and/or includes direct coupling between items and/or indirect coupling between items via an intervening item (e.g., an item includes, but is not limited to, a component, an element, a circuit, and/or a module) where, for indirect coupling, the intervening item does not modify the information of a signal but may adjust its current level, voltage level, and/or power level. As may further be used herein, inferred coupling (i.e., where one element is coupled to another element by inference) includes direct and indirect coupling between two items in the same manner as “coupled to.” As may even further be used herein, the term “operable to” indicates that an item includes one or more of power connections, input(s), output(s), etc., to perform one or more its corresponding functions and may further include inferred coupling to one or more other items. As may still further be used herein, the term “associated with,” includes direct and/or indirect coupling of separate items and/or one item being embedded within another item. As may be used herein, the term “compares favorably” or “favorable determination” indicates that a comparison between two or more items, signals, etc., provides a desired relationship. For example, when the desired relationship is that first signal has a greater magnitude than second signal, a favorable comparison may be achieved when the magnitude of the first signal is greater than that of the second signal or when the magnitude of the second signal is less than that of the first signal.

The present invention has also been described above with the aid of method steps illustrating the performance of specified functions and relationships thereof. The boundaries and sequence of these functional building blocks and method steps have been arbitrarily defined herein for convenience of description. Alternate boundaries and sequences can be defined so long as the specified functions and relationships are appropriately performed. Any such alternate boundaries or sequences are thus within the scope and spirit of the claimed invention.

Moreover, although described in detail for purposes of clarity and understanding by way of the aforementioned embodiments, the present invention is not limited to such embodiments. It will be obvious to one of average skill in the art that various changes and modifications may be practiced within the spirit and scope of the invention, as limited only by the scope of the appended claims.

What is claimed is:

1. A dual mode wireless power module for a device comprises:
a wireless transceiver operable to:
communicate peripheral power information indicating a wireless power configuration; and
a wireless power transceiver circuit operable to:
determine, based upon the power information, a power status of another device identified by the peripheral power information,
when the power status of the another device is favorable, the wireless power transceiver circuit is placed in a wireless power receive mode, wherein the wireless power transceiver circuit converts received wireless power into a voltage; and
when the power status of the another device is unfavorable, the wireless power transceiver circuit is placed in a wireless power transmit mode, wherein the wireless power transceiver circuit converts a power source of the device into wireless power for transmission.

2. The dual mode wireless power module of claim 1, wherein the peripheral information comprises:
power source identifier;
wireless power capability;
device power priority; and
at least one of:
communication protocol;
input data;
input command;
output data; and
output command.

3. The dual mode wireless power module of claim 2, wherein the power status is favorable when the another device is coupled to an external, substantially constant, power source, as indicated by the power source identifier.

4. The dual mode wireless power module of claim 1, wherein the power status is favorable and unfavorable to place the dual mode wireless power module in a duplex mode of operation, wherein the wireless power transceiver circuit converts the received wireless power from the another device into the voltage, and converts the power source of the device into the wireless power for transmission to yet another device.

5. The dual mode wireless power module of claim 1, wherein the power status is favorable when the voltage strength of a battery of the another device is substantially greater than that of another battery local to the wireless power transceiver circuit.

6. The dual mode wireless power module of claim 1, wherein the wireless power transceiver is further operable to:
communicate information regarding the wireless power received by the dual mode wireless power module; and
cause the wireless power transceiver circuit to disengage the wireless power when a signal strength of the wireless power falls below a threshold.

7. The dual mode wireless power module of claim 6, wherein the information regarding the wireless power comprises at least one of:
control channel protocol;
frequency of the wireless power;
impedance matching parameters; and
resonant frequency tuning parameters.

8. The dual mode wireless power module of claim 1 wherein the primary device includes a computer; and
the another device including at least one of:
a keyboard,
a mouse,
a track ball,
a game controller,
a cell phone,
a hard drive,
a memory device,
a digital camera, and
a personal A/V player;
a medical device; and
a data collection device with remote readout.

9. The dual mode wireless power module of claim 1 wherein the wireless power produces one of an inductive coupling or a resonant inductive coupling.

10. A handheld device comprises:
a battery;
a battery charger operable to utilize a supply voltage to charge the battery;
a wireless transceiver operable to:
communicate power information indicating a wireless power configuration; and
a dual mode wireless power transceiver circuit operable to:
determine, based upon the power information, a power status of another device identified by the power information,
when the power status of the another device is favorable, the wireless power transceiver circuit is placed in a wireless power receive mode, wherein the dual mode wireless power transceiver circuit converts wireless power into the supply voltage; and
when the power status of the another device is unfavorable, the dual mode wireless power transceiver circuit is placed in wireless power transmit mode, wherein the wireless power transceiver circuit converts a power source of the device into the wireless power; and
a processing module operable to coordinate:
the charging of the battery when the dual mode wireless power transceiver circuit is in the power receive mode; and
the communicating of the power information.

11. The handheld device of claim 10, wherein the power information comprises:
power source identifier;
wireless power capability;
device power priority; and
at least one of:
communication protocol;
input data;
input command;
output data; and
output command.

12. The handheld device of claim 10, wherein the power status is favorable when the another device is coupled to an external power source, as indicated by the power source identifier, wherein the external power source is substantially constant.

13. The handheld device of claim 10, wherein the power status is favorable when the voltage strength of a battery of the another device is substantially greater than that of a battery local to the wireless power transceiver circuit.

14. The handheld device of claim 10, wherein the wireless power transceiver is further operable to:
communicate information regarding the wireless power received by the dual mode wireless power module; and
cause the wireless power transceiver circuit to disengage the wireless power when a signal strength of the wireless power falls below a threshold.

15. The handheld device of claim 14, wherein the information regarding the wireless power comprises at least one of:
control channel protocol;
frequency of the wireless power;
impedance matching parameters; and
resonant frequency tuning parameters.

16. The handheld device of claim 10 wherein the device includes a computer; and
the another device including at least one of:
a keyboard,
a mouse,
a track ball,
a game controller,
a cell phone,
a hard drive,
a memory device,
a digital camera,
a personal A/V player;
a medical device; and
a data collection device with remote readout.

17. An integrated circuit (IC) comprises:
at least a portion of a wireless power transceiver circuit that is operable to:
convert a wireless power into a supply voltage; and
convert a power source into the wireless power; and
at least a portion of a battery charger that is operable to charge a battery based on the supply voltage;
a wireless transceiver operable to:
communicate control channel information regarding the wireless power with another wireless power transmitter circuit of a device; and
communicate at least one of data and command with the device; and
a processing module operable to
determine, based upon the data, a power status of another device identified by the peripheral power information,
when the power status of the another device is favorable, the wireless power transceiver circuit is placed in a power receive mode, wherein the dual mode wireless power transceiver circuit converts the wireless power into the supply voltage; and
when the power status of the another device is unfavorable, the dual mode wireless power transceiver circuit is placed in a power transmit mode, wherein the wireless power transceiver circuit converts a power source of the device into the wireless power;
coordinate the charging of the battery with the supply voltage when the dual mode wireless power transceiver is in a receive mode;
coordinate conversion of the wireless power into the supply voltage; and
coordinate communication of the control channel information with the device.

18. The IC of claim 17, wherein the processing module is further operable to:
execute a function corresponding to the at least one of the data and the command.

19. The IC of claim 17 further comprises:
at least a portion of the dual power conversion transceiver circuit that is operable to convert the supply voltage into a second wireless power.

20. The IC of claim 17, wherein the control channel information regarding the wireless power comprises one or more of:
control channel protocol;
frequency of the wireless power;
impedance matching parameters; and
resonant frequency tuning parameters.
